(19) United States
(12) Patent Application Publication
(10) Pub. No.: US 2024/0047791 A1
(43) Pub. Date: Feb. 8, 2024

(54) LITHIUM SECONDARY BATTERY

(71) Applicant: SK ON CO., LTD., Seoul (KR)

(72) Inventors: Keun Jun LEE, Daejeon (KR); Kyu Beom KIM, Daejeon (KR)

(21) Appl. No.: 18/347,575

(22) Filed: Jul. 6, 2023

(30) Foreign Application Priority Data
Aug. 4, 2022 (KR) 10-2022-0097384

(51) Int. Cl. H01M 50/124; H01M 10/052; H01M 50/105; H01M 50/186; H01M 50/129; H01M 50/119; H01M 50/121; H01M 50/133

(52) U.S. Cl. CPC H01M 50/1243; H01M 10/052; H01M 50/105; H01M 50/186; H01M 50/129; H01M 50/119; H01M 50/121; H01M 50/133

(57) ABSTRACT

A lithium secondary battery according to exemplary embodiments includes an electrode assembly and a pouch in which the electrode assembly is housed. The pouch includes a housing portion configured to house the electrode assembly; a peripheral portion around the housing portion; and a coating portion formed along an inner lateral surface of the housing portion and spaced apart from a side portion of the electrode assembly.

### CROSS-REFERENCE TO RELATED APPLICATION

This patent document claims the priority and benefits of Korean Patent Application No. filed at the Korean Intellectual Property Office (KIPO) on Aug. 4, 2022, the entire disclosure of which is incorporated herein by reference.

### BACKGROUND

### 1. Field

The present disclosure relates to a lithium secondary battery, and more specifically, to a lithium secondary battery including a pouch configured to house an electrode assembly.

### 2. Description of the Related Art

A secondary battery is a battery which can be repeatedly charged and discharged. With rapid progress of information and communication, and display industries, the secondary battery has been widely applied to various portable telecommunication electronic devices such as a camcorder, a mobile phone, a laptop computer as a power source thereof. Recently, a battery pack including the secondary battery has also been developed and applied to an eco-friendly automobile such as a hybrid vehicle as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight, such that development thereof has been proceeded in this regard.

The lithium secondary battery may include: an electrode assembly including a cathode, an anode, and a separation membrane (separator); and an electrolyte in which the electrode assembly is impregnated. In addition, the lithium secondary battery may further include, for example, a pouch-shaped outer case in which the electrode assembly and the electrolyte are housed.

The pouch-shaped outer case may be formed of a substrate layer for sealing after housing the electrode assembly, a metal layer, and an adhesive layer for bonding the substrate layer and the metal layer, etc.

Meanwhile, the electrode assembly is housed in the pouch in a rectangular parallelepiped shape, and edges or vertex portions of the electrode assembly are sharp, such that the edges of the pouch may be damaged. In addition, the edge of the pouch may be prone to cracking even by external friction, which may lead to leakage of the electrolyte inside the cell, such that the battery can be deteriorated or exploded. Therefore, it is necessary to enhance durability of the pouch-shaped outer case in order to secure safety of the battery.

For example, Korean Patent Laid-Open Publication No. 10-2014-0030431 discloses a pouch case intended to improve structural safety, but the manufacturing process thereof is cumbersome and safety of the battery may not be sufficiently provided.

### SUMMARY

An object of the present disclosure is to provide a lithium secondary battery having improved structural safety.

According to an aspect of the present disclosure, there is provided a lithium secondary battery including: an electrode assembly; and a pouch in which the electrode assembly is housed, wherein the pouch includes: a housing portion configured to house the electrode assembly; a peripheral portion around the housing portion; and a coating portion formed along an inner lateral surface of the housing portion and spaced apart from a side portion of the electrode assembly.

In one embodiment, the pouch may include a terrace region defined by a separation space between the coating portion and the side portion of the electrode assembly.

In one embodiment, a ratio of an average width of the terrace region in a long-axis direction to a long-axis length of the housing portion may be ⅕ to 1/50.

In one embodiment, a ratio of an average thickness of the coating portion to an average thickness of the pouch may be 1/10 to 1/50.

In one embodiment, the housing portion may further include a central surface facing the electrode assembly in a thickness direction thereof, and the coating portion may be formed on the inner lateral surface of the housing portion and may not be formed on the central surface.

In one embodiment, the peripheral portion may include a sealing surface, and the coating portion may not be formed on the sealing surface.

In one embodiment, the housing portion may include a first housing portion and a second housing portion which face each other, and the peripheral portion may further include a folding surface which divides the first housing portion and the second housing portion.

In one embodiment, the coating portion may not be formed on the folding surface.

In one embodiment, the pouch may have a laminate structure which includes a sealant layer, a metal layer and a coating layer.

In one embodiment, the sealant layer may include a polyolefin resin, the metal layer may include aluminum, and the coating layer may include nylon.

In one embodiment, the coating portion may have a greater tensile strength than a tensile strength of the sealant layer.

According to exemplary embodiments, the lithium secondary battery may have a coating portion formed along an inner lateral surface of a housing portion of a pouch. Thereby, damage to the pouch may be prevented by the coating portion.

For example, cracks and damage to the pouch caused by the repeated contact of an edge portion of an electrode assembly with the pouch or during transfer and use of the lithium secondary battery may be prevented. Accordingly, structural safety of the lithium secondary battery may be improved.

The lithium secondary battery has the coating portion formed along the inner lateral surface of the housing portion, so that an increase in the thickness of the battery may be prevented. In addition, when manufacturing a battery module, the number of batteries that can be housed in the module may be increased. Accordingly, assembly performance of the battery pack may be improved and energy density may be increased.

The lithium secondary battery according to one embodiment may effectively and simply improve the structural safety of the pouch without addition of new equipment or improvement of the existing equipment.

### BRIEF DESCRIPTION OF THE DRAWINGS

FIGS. 1 and 2 are schematic perspective views illustrating a lithium secondary battery according to an example embodiment, respectively.

FIG. 3 is a cross-sectional view taken on line A-A′ of FIG. 1 in a thickness direction of the battery.

FIG. 4 is a cross-sectional view taken on line B-B′ of FIG. 1 in the thickness direction.

FIG. 5 a cross-sectional view illustrating a laminate structure of a lithium secondary battery pouch according to an example embodiment.

### DETAILED DESCRIPTION OF THE INVENTION

According to example embodiments, a lithium secondary battery including a pouch configured to house an electrode assembly is provided.

Hereinafter, preferred embodiments of the present disclosure will be described in detail with reference to the accompanying drawings. However, since the drawings attached to the present disclosure are only given for illustrating one of several preferred embodiments of present disclosure to easily understand the technical spirit of the present disclosure with the above-described invention, it should not be construed as limited to such a description illustrated in the drawings.

The terms “upper side,” “lower side,” “one side,” “inner side,” “upper portion,” “lower portion,” etc. used in the present disclosure do not limit the absolute position or order, but are used in a relative sense to distinguish different components or portions.

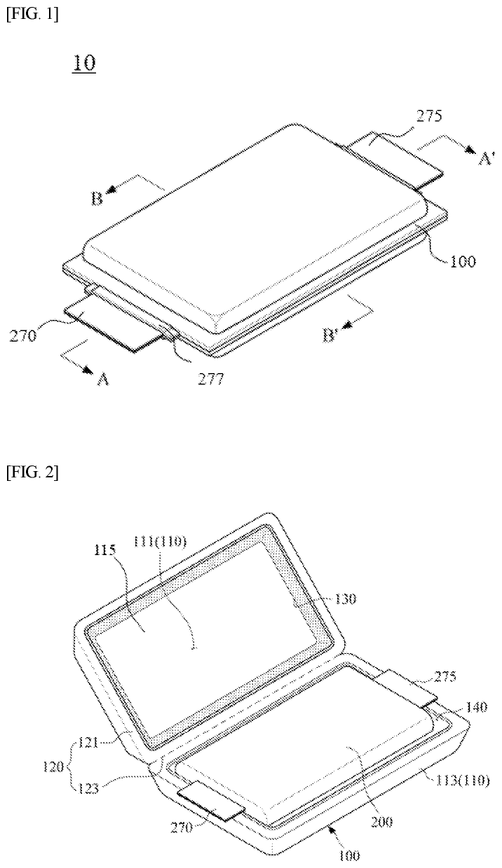

FIG. 1 is a schematic perspective view illustrating a lithium secondary battery according to example embodiments. FIG. 2 is a perspective view schematically illustrating a state in which an electrode assembly is housed in one housing portion of the lithium secondary battery according to example embodiments.

Referring to FIGS. 1 and 2, a lithium secondary battery 10 may include an electrode assembly 200 and a pouch 100 configured to house the electrode assembly 200 while surrounding the electrode assembly 200.

In one embodiment, the electrode assembly 200 may include a first electrode tab 270 and a second electrode tab 275 respectively formed on both sides thereof. In one embodiment, both the first electrode tab 270 and the second electrode tab 275 may be formed on one side of the electrode assembly 200.

In one embodiment, some of the electrode tabs 270 and 275 may be surrounded by an insulation portion 277. For example, the insulation portion 277 may adhere the electrode tabs 270 and 275 to the pouch 100, and prevent electricity generated in the electrode assembly 200 from flowing into the pouch 100 through the electrode tabs 270 and 275 while maintaining sealing between the electrode tabs 270 and 275 and the pouch 100.

The pouch 100 may include a housing portion 110 configured to house the electrode assembly 200 and a peripheral portion 120 located around the housing portion 110.

The housing portion 110 may include a first housing portion 111 and a second housing portion 113 which face each other. The housing portion 110 may have a recess shape disposed to be recessed in a predetermined depth from the peripheral portion 120. The electrode assembly 200 may be housed in the housing portion 110, and may have a size and shape enough to house the electrode assembly 200.

In one embodiment, the housing portion 110 may include an inner lateral surface (not illustrated) and a central surface 115, which are formed an inner surface thereof. The inner lateral surface may refer to a region formed along edge sidewalls of the housing portion 110 to surround the electrode assembly 200 along a thickness of the electrode assembly 200. The central surface 115 may refer to a region connected to the inner lateral surface of the housing portion 110 and facing the electrode assembly 200 in a thickness direction thereof.

The peripheral portion 120 may refer to an inner region of the pouch 100, which surrounds the housing portion 110 configured to house the electrode assembly 200. The peripheral portion 120 may include tab drawing portions (not illustrated) formed at portions where the electrode tabs 270 and 275 are drawn out, and side peripheral portions (not illustrated) formed at portions where the electrode tabs 270 and 275 are not drawn out.

For example, the first electrode tab 270 and the second electrode tab 275 may be formed on both side portions (e.g., upper and lower side portions) of the electrode assembly 200, respectively, and the first electrode tab 270 and the second electrode tab 275 respectively formed on the both side portions may protrude to an outside through the tab drawing portions respectively formed on the upper and lower side portions of the pouch 100.

For example, both the first electrode tab 270 and the second electrode tab 275 may be formed on one side (e.g., upper or lower side) of the electrode assembly 200, and the first electrode tab 270 and the second electrode tab 275 formed on the one side may protrude to the outside through the tab drawing portions formed on the upper or lower side portion of the pouch 100.

In one embodiment, the peripheral portion 120 may include a sealing surface 121 formed on an inner surface thereof. The sealing surface 121 refers to, for example, a surface to which a sealing jig comes into contact with and is attached in a process of sealing the pouch during a battery manufacturing process.

The peripheral portion 120 may further include a folding surface 123 formed on the inner surface thereof. For example, the housing portion 110 may be divided into the first housing portion 111 and the second housing portion 113 by the folding surface 123. As shown in FIG. 2, the second housing portion 113 may house a lower portion of the electrode assembly 200, and the first housing portion 111 may cover an upper portion of the electrode assembly 200. In some embodiments, the lower portion of the electrode assembly 200 may be inserted into the first housing portion 111 and the upper portion of the electrode assembly 200 may be covered by the second housing portion 113.

In addition, the folding surface 123 is not limited to a specific structure, and may have, for example, a structure protruding to a predetermined height, or may be a virtual segment or a virtual region.

When the electrode assembly 200 is inserted into the first housing portion 111 or the second housing portion 113, and the first housing portion 111 or the second housing portion 113 is folded along the folding surface 123, the electrode assembly 200 may be surrounded by the pouch 100. In this case, the first housing portion 111 and the second housing portion 113 may face each other, and the peripheral portion around the first housing portion 111 and the peripheral portion surrounding the second housing portion 113 may face and come into contact with each other. The sealing surface 121 may be formed by pressing or fusing the peripheral portions 120 by a jig along the edges of the peripheral portions 120 which face and come into contact with each other.

The pouch 100 may include a coating portion 130 formed along the inner lateral surface of the housing portion 110. The coating portion 130 may be spaced apart from one side of the electrode assembly 200 in a housing state.

In some embodiments, the coating portion 130 may be formed on the entire or a part of the inner lateral surface of the housing portion 110. In one embodiment, the coating portion 130 may be formed on 50% or more of the entire inner lateral surface of the housing portion 110, for example, may be formed on the entire inner lateral surface of the housing portion 110. In this case, damage to the edge of the pouch 100 by the electrode assembly 200 during transfer and use of the lithium secondary battery 10 may be effectively prevented.

Additionally, structural deterioration (discoloration, corrosion, or decomposition) of the pouch 100 due to cracks or electrolyte may be prevented, such that the safety of the battery may be secured. Further, the structural safety of the lithium secondary battery 10 may be effectively improved without addition of new equipment or improvement of the existing equipment.

In one embodiment, the coating portion 130 may include a polymer compound. The polymer compound may be a curable material which forms a cross-link by a chemical reaction to form intermolecular bonds when irradiating it with heat or light (e.g., UV rays). For example, the polymer compound may include polybutadiene, polyurethane, polyimide, acetate, polyester, polyphenylenesulfide (PPS), polypropylene, styrene-butadiene copolymer, (meth)acrylic acid copolymer polymer, (meth)acrylate copolymer, polyacrylonitrile, polyvinyl chloride, polyfluoro compound, polyvinyl alcohol, polycyanoacrylate and the like. When the coating portion 130 includes the polymer compound, structural strength may be improved by reinforcing elastic and restoring forces of the inner surface of the pouch 100.

For example, the coating portion 130 may be formed by coating or applying a coating solution including the polymer compound to the inner lateral surface of the housing portion 110. In addition, the coating portion 130 may be formed by attaching a film or tape including the polymer compound.

The coating solution may include one or two or more solvents selected from water, glycerol, ethylene glycol, propylene glycol, dimethyl sulfoxide, dimethyl formamide, acetonitrile, ethylene carbonate, furfuryl alcohol, methanol and pyrrolidine as necessary.

In some embodiments, a content of the polymer compound based on 100 parts by weight (“wt. parts”) of the solvent may be 1 to 50 wt. parts, or 5 to 40 wt. parts, or 10 to 40 wt. parts. Within the above range, scratch resistance and chemical resistance of the pouch 100 may be further improved.

In some embodiments, the coating solution may further include a photo-initiator and a thickener as necessary.

In one embodiment, a ratio of an average thickness of the coating portion 130 to an average thickness of the pouch 100 may be 1/10 to 1/50, for example, 1/10 to 1/30. Within the above range, the coating portion 130 may sufficiently serve as a protective layer for protecting the pouch 100 from an impact, such that the structural safety of the pouch 100 may be further improved.

The average thickness may be a value obtained by measuring thicknesses of the pouch 100 or the coating portion 130 along the profile of the pouch 100 or the coating portion 130, and calculating an arithmetic mean of the measured thicknesses. In one embodiment, when the pouch 100 or the coating portion 130 has a constant thickness, the average thickness may mean the constant thickness.

The pouch 100 may include a terrace region 140 which is a space formed in the housing portion 110 except for a space in which the electrode assembly 200 is housed. For example, the terrace region 140 may be a space formed by spaced apart from one side portion of each of the coating portion 130 and the electrode assembly 200. The terrace region 140 may be defined by a separation space between the coating portion 130 and the side portion of the electrode assembly 200. A long-axis of the terrace region 140 may be in the same direction as a short-axis of the housing portion 110, and a short-axis of the terrace region 140 may be in the same direction as a long-axis of the housing portion 110.

In one embodiment, a ratio of an average width of the terrace region 140 in the long-axis direction of the terrace region 140 to a long-axis length of the housing portion 110 may be ⅕ to 1/50, for example, ⅕ to 1/25. For example, the electrode assembly 200 may expand according to repeated use of the battery, and in order to house the expanded electrode assembly 200, an extra space within the pouch 100, e.g., the terrace region 140 may be required. In addition, as the average width of the terrace region 140 is formed to be equal or less than ⅕ of the long-axis length of the housing portion 110, an empty space within the housing portion 110 may be minimized, thereby further increasing an energy density of the battery.

The average width may be a value obtained by measuring the widths of the terrace region 140 along the long-axis direction profile of the terrace region 140, and calculating an arithmetic mean of the measured widths. In one embodiment, when the terrace region 140 has a constant width in the long-axis direction, the average width may mean the constant width.

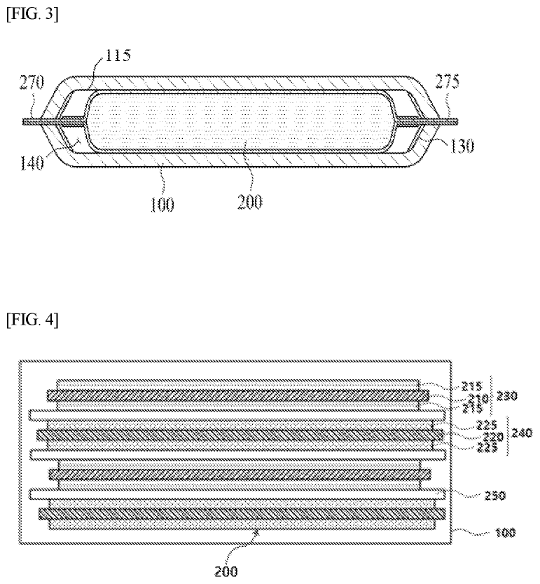

FIG. 3 is a cross-sectional view taken on line A-A′ of FIG. 1 in a thickness direction of the battery.

In one embodiment, the coating portion 130 may be formed on the inner lateral surface of the housing portion 110 of the pouch, and may not be formed on the central surface 115 of the housing portion 110. Accordingly, damage to the inner wall of the pouch 100 caused by frequent contact between the electrode assembly 200 and the pouch 100 may be intensively protected. In addition, in this case, it is possible to prevent the thickness of the battery from becoming thicker, and increase the number of batteries that can be housed in a module when manufacturing the battery module. Therefore, assembly performance of the battery may be improved and energy density may be increased.

In one embodiment, the coating portion 130 may partially extend from the inner lateral surface of the housing portion 110 onto the central surface 115 of the housing portion 110. For example, the coating portion 130 may be formed on 50% or less of the entire central surface 115, and preferably, is formed on 20% or less of the entire central surface 115. Accordingly, the coating portion 130 may protect the pouch 100 as a whole together with the inner edge portion of the pouch 100 from an external impact.

In one embodiment, the coating portion 130 may not be formed on the sealing surface 121. In one embodiment, the coating portion 130 may not be formed on the folding surface 123. When the coating portion 130 is formed on the sealing surface 12 or the folding surface 123, there is a structural limitation in preventing cracks from occurring at the edges of the desired pouch 100. In one embodiment, the coating portion 130 is formed only on the inner surface of the housing portion 110 of the pouch 100.

FIG. 4 is a cross-sectional view taken on line B-B′ of FIG. 1 in the thickness direction. Referring to FIG. 4, the electrode assembly 200 may include a cathode 230, an anode 240, and a separation membrane 250 interposed between the cathode 230 and the anode 240. In addition, for the convenience of description, the coating portion is not illustrated in FIG. 4.

The cathode 230 may include a cathode current collector 210 and a cathode active material layer 215 formed by applying a cathode active material to the cathode current collector 210. The cathode active material may include a compound capable of reversibly intercalating and deintercalating lithium ions.

The cathode 230 may be manufactured by applying a cathode slurry to the cathode current collector 210, followed by drying and compressing the same. The cathode slurry may be prepared by mixing and stirring the cathode active material with a binder, a conductive material, and/or a dispersant in a solvent.

The cathode current collector 210 may include a metal material which has no reactivity in a charging/discharging voltage range of the lithium secondary battery 10 and facilitates application and adhesion of the cathode active material. In one embodiment, the cathode current collector 210 may include stainless steel, nickel, aluminum, titanium, copper, zinc, or an alloy thereof, for example, includes aluminum or an aluminum alloy.

The cathode active material may include lithium-transition metal composite oxide particles. For example, the lithium-transition metal composite oxide particles may include nickel (Ni), and may further include at least one of cobalt (Co) and manganese (Mn).

The lithium-transition metal composite oxide particles may be represented by Formula 1 below.

[Formula 1]

Li₁₊ₐNi_{1-(x+y)}CoₓM_{y}O₂

In Formula 1, a, x and y may be in a range of −0.05≤a≤0.2, 0.01≤x≤0.3, and 0.01≤y≤0.3, respectively, and M may be one or more elements selected from Mn, Al, Mg, Sr, Ba, B, Si, Ti, Ta, Zr and W.

In one embodiment, in Formula 1, a, x and y may be in a range of 0.05≤a≤0.2, 0.001≤x≤0.2, and 0.01≤y<0.2, respectively, and M may be one or more elements selected from Mn and Al.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for forming the cathode. In this case, an amount of the binder for forming the cathode active material layer may be reduced, and thereby, the output and capacity of the secondary battery may be improved.

The conductive material may be included to facilitate electron transfer between the active material particles. For example, the conductive material may include a carbon-based conductive material such as graphite, carbon black, graphene, or carbon nanotubes and/or a metal-based conductive material such as tin, tin oxide, titanium oxide, or a perovskite material such as LaSrCoO₃, and LaSrMnO₃, etc.

The anode 240 may include an anode current collector 220 and an anode active material layer 225 disposed by applying an anode active material to the anode current collector 220.

As the anode active material, those known in the art, which are capable of intercalating and deintercalating lithium ions, may be used without particular limitation thereof. For example, carbon-based materials such as crystalline carbon, amorphous carbon, carbon composite, and carbon fiber, etc.; a lithium alloy; a silicon (Si)-based active material, and the like may be used. Examples of the amorphous carbon may include hard carbon, cokes, mesocarbon microbead (MCMB), mesophase pitch-based carbon fiber (MPCF) or the like.

Examples of the crystalline carbon may include graphite-based carbon such as natural graphite, artificial graphite, graphite cokes, graphite MCMB, graphite MPCF or the like. Elements included in the lithium alloy may include, for example, aluminum, zinc, bismuth, cadmium, antimony, silicone, lead, tin, gallium, indium or the like.

The silicon-based active material may include SiOx (0<x<2) or SiOx containing a lithium compound (0<x<2). The SiOx containing the lithium compound may be SiOx containing lithium silicate. The lithium silicate may be present in at least a portion of SiOx (0<x<2) particles, for example, may be present inside and/or on surfaces of the SiOx (0<x<2) particles. In one embodiment, the lithium silicate may include Li₂SiO₃, Li₂Si₂O5, Li₄SiO₄, Li₄Si₃O₈ and the like.

The silicon-based active material may include, for example, a silicon-carbon composite compound such as silicon carbide (SiC).

The anode current collector 220 may include stainless steel, copper, nickel, aluminum, titanium, or an alloy thereof For example, the anode current collector 220 includes copper or a copper alloy.

For example, a form of slurry may be prepared by mixing the anode active material with a binder, a conductive material and/or thickener in a solvent, followed by stirring the same. The slurry may be applied to at least one surface of the anode current collector 220, followed by compressing and drying to prepare the anode 240 including the anode active material layer 225.

As the binder and the conductive material, materials which are substantially the same as or similar to the materials described in the cathode active material layer 215 may be used. A binder for forming the anode active material layer 225 may include, for example, an aqueous binder such as styrene-butadiene rubber (SBR) for consistency with the carbon-based active material, and may be used together with a thickener such as carboxymethyl cellulose (CMC).

The separation membrane 250 may be interposed between the cathode 230 and the anode 240. The separation membrane 250 may include a porous polymer film made of a polyolefin polymer such as ethylene homopolymer, propylene homopolymer, ethylene/butene copolymer, ethylene/hexene copolymer, ethylene/methacrylate copolymer. The separation membrane may include a nonwoven fabric made of glass fiber having a high melting point, polyethylene terephthalate fiber or the like.

In some embodiments, the anode 240 may have an area and/or volume (e.g., a contact area with the separation membrane 250) larger than those/that of the cathode 230. Thereby, lithium ions generated from the cathode 230 may be smoothly moved to the anode 240 without being precipitated in the middle, for example. Therefore, effects of simultaneously improving the output and stability through a combination with the above-described lithium composite oxide particles or the cathode active material may be more easily implemented.

According to one embodiment, an electrode cell is defined by the cathode 230, the anode 240, and the separation membrane 250, and a plurality of electrode cells may be stacked to arrange, for example, a jelly roll type electrode assembly. For example, the electrode assembly may be arranged by winding, laminating, folding, etc. the separation membrane.

The electrode assembly 200 may be housed in the pouch 100 together with the electrolyte to define the lithium secondary battery 10. A non-aqueous electrolyte may be used as the electrolyte.

The non-aqueous electrolyte includes a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulforane, γ-butyrolactone, propylene sulfite, tetrahydrofurane, and the like may be exemplified. These compounds may be used alone or in combination of two or more thereof.

The lithium secondary battery 10 according to an embodiment may be an all-solid-state lithium secondary battery, and in this case, the cathode, the anode, and the electrolyte may be used through change or adjustment.

Electrode tab may be arranged from the cathode current collector 210 and the anode current collector 220, respectively, which belong to each electrode cell, and may extend to one side of the pouch 100. The electrode tabs may include the first electrode tab 270 and the second electrode tab 275 which are fused together with one side portion of the pouch 100, and extend or exposed to an outside of the pouch 100.

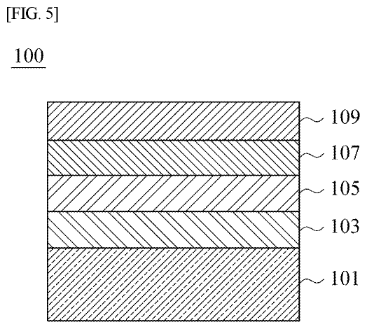

FIG. 5 a cross-sectional view illustrating a laminate structure of a lithium secondary battery pouch according to exemplary embodiments.

Referring to FIG. 5, the pouch 100 may have a laminate structure including a sealant layer 101, a metal layer 105, and a coating layer 109. In addition, a first adhesive layer 103 may be formed between the sealant layer 101 and the metal layer 105, and a second adhesive layer 107 may be formed between the metal layer 105 and the coating layer 109.

Referring to FIG. 2, after the electrode assembly 200 is housed in the first housing portion 111 or the second housing portion 113 of the pouch, the first housing portion 111 or the second housing portion 113 may be folded along the folding surface 123. The sealant layers 101 may be located on surfaces of the housing portions facing each other. The sealant layers 101 may be bonded to each other at the edge sealing surface 121 of the peripheral portion 120 surrounding the first housing portion 111 or the second housing portion 113, respectively, to seal the pouch 100.

For example, the sealant layer 101 may include a fusible material, and in this case, the pouch 100 may be sealed by thermal fusion. The sealant layer 101 may have a single film structure made of any one material selected from the group consisting of polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, Teflon, and glass fiber, or a composite film structure made of two or more materials described above.

In one embodiment, the sealant layer 101 may include a laminate of homopolypropylene and modified polypropylene as polypropylene. For example, the sealant layer 101 may have a total thickness of about 60 to 100 μm, or about 70 to 90 μm.

The metal layer 105 may prevent invasion of external moisture, gas, etc. to the electrode assembly 200 to improve a mechanical strength of the pouch 100, and may prevent chemical substances injected into the pouch 100 from being discharged to an outside of the pouch 100.

For example, the metal layer 105 may include iron (Fe), chromium (Cr), manganese (Mn), nickel (Ni), aluminum (Al), an alloy thereof, or the like, and may also include carbon. In one embodiment, the metal layer 105 includes aluminum (Al). In this case, flexibility of the pouch 100 may be further improved. In addition, the metal layer 105 may have a thickness of about 30 to 50 μm, for example, about 35 to 45 μm.

The coating layer 109 may include nylon, and in this case, the nylon may be biaxially stretched. For example, the coating layer 109 may have a thickness of about 10 to 20 μm.

In one embodiment, the sealant layer 101, the metal layer 105, and the coating layer 109 may be adhered to each other by the adhesive layers 103 and 107. For example, the adhesive layers 103 and 107 may have a thickness of about 3 μm or less, respectively. For example, the adhesive layers 103 and 107 may have a thickness of about 0.1 to 3 μm, respectively. When the thicknesses of the adhesive layers 103 and 107 satisfy the above range, adhesion of each layer may be improved, as well as, it is possible to prevent the pouch 100 from becoming excessively thicker.

Referring to FIGS. 2 and 5, the coating portion 130 may have a greater tensile strength than a tensile strength of the sealant layer 101. For example, when the sealant layer 101 includes a laminate of the homopolypropylene and the modified polypropylene as polypropylene, the sealant layer 101 may have a tensile strength (ASTM D638) of 140 to 200 MPa. For example, when the coating portion 130 includes polyimide, the coating portion 130 may have a tensile strength (ASTM D638) of 150 to 250 MPa. When the tensile strength of the coating portion 130 is greater than the tensile strength of the sealant layer 101, resistance may be further improved, and the pouch 100 may be effectively protected even when a physical force is applied thereto from the outside.

Hereinafter, exemplary examples are proposed to facilitate understanding of the present disclosure. However, the following examples are only given for illustrating the present disclosure and those skilled in the art will obviously understand that various alterations and modifications are possible within the scope and spirit of the present disclosure. Such alterations and modifications are duly included in the appended claims.

Examples and Comparative Examples

(1) Preparation of Electrode Assembly LiNi_{0.8}Co_{0.1}Mn_{0.1}O₂ as a cathode active material, carbon black as a conductive material, and polyvinylidene fluoride (PVDF) as a binder were mixed in a mass ratio of 95:3:2 to prepare a cathode slurry. Then, the cathode slurry was applied to an aluminum substrate, followed by drying and pressing to prepare a cathode.

An anode slurry was prepared using 92% by weight (“wt. %”) of artificial graphite as an anode active material, 2 wt. % of a styrene-butadiene rubber (SBR) binder, 1 wt. % of CMC as a thickener, and 5 wt. % of amorphous artificial graphite as a conductive material. Then, the anode slurry was applied to a copper substrate, followed by drying and pressing to prepare an anode.

An electrode assembly was prepared by disposing the prepared cathode and anode with a polyethylene (PE) separation membrane (thickness: 15 μm) interposed therebetween to from an electrode cell, followed by winding the same.

(2) Preparation of Coating Solution

A coating solution (viscosity: 2,000 to 2,500 cps) was prepared by mixing 15 wt. % of polyimide with N-methyl-2-pyrrolidone (NMP) as a solvent.

(3) Manufacture of Lithium Secondary Battery

A pouch (including: a sealant layer of PP film with a thickness of 80 μm; a metal layer of aluminum thin film with a thickness of 40 μm; and a coating layer of nylon film with a thickness of 15 μm) was prepared, and the coating solution prepared in the above (2) was sprayed on the entire inner lateral surface of a housing portion of the pouch to form a coating layer having a thickness of 5 μm. The sealant layer had a tensile strength of 140 MPa, which was measured according to ASTM D638, and the coating layer had a tensile strength of 160 MPa, which was measured according to ASTM D638.

The electrode assembly was housed in the pouch, followed by sealing the pouch. Thereafter, a secondary battery was manufactured by injecting an electrolyte and then sealing the pouch. The electrolyte used herein was prepared by dissolving 1M LiPF₆ solution in a mixed solvent of EC/EMC/DEC (25/45/30; volume ratio), and then adding 0.5 wt. % of 1,3-propanesultone (PS) thereto.

As shown in Table 1 below, lithium secondary batteries according to the examples and comparative examples were prepared by varying the position of the coating portion in the pouch.

TABLE 1

| | Position of coating part |
|---|---|
| Example 1 | Entire inner side face of pouch housing portion |
| | (100% of entire inner side face) |
| Example 2 | A portion of inner side face of pouch housing |
| | portion (50% of entire inner side face) |
| Comparative Example 1 | Central surface of pouch housing part |
| Comparative Example 2 | Peripheral portion of pouch housing part |

Experimental Example

Evaluation of Safety

The lithium secondary batteries according to the examples and comparative examples were placed on a mounting plate for evaluation of vibration, and vibration performance were evaluated by changing the frequency and power spectrum density of the batteries as shown in Table 2 below to 100% state of charge (SOC) under conditions of 25° C. for 8 hours on 5 sides and 10 to 20 m/s² of RMS acceleration, through inspection of changes in the capacity, output, and resistance before and after the evaluation and appearance. Evaluation results are shown in Table 3 below.

TABLE 2

| | The number of vibrations (Hz) | | | | | | | |
|---|---|---|---|---|---|---|---|---|
| | 5 | 10 | 55 | 180 | 300 | 360 | 1000 | 2000 |
| Power spectrum | 3 | 20 | 6.5 | 0.25 | 0.25 | 0.14 | 0.14 | 0.14 |
| density ((m/s²)²/Hz) | | | | | | | | |

<Standards for Evaluation>

Normal: No change in the capacity, output and resistance (less than 1%), appearance (torn or dented) before and after the vibration test was observed, and no safety problem (1 to 2° C. of temperature was increased, ignited) occurred

Abnormal: Changes in the capacity, output and resistance (1% or more), appearance (torn or dented) before and after the vibration test were observed, and safety problems (1 to 2° C. of temperature was increased, ignited) occurred.

TABLE 3

| | Evaluation of vibration performance |
|---|---|
| Example 1 | Normal |
| Example 2 | Normal |
| Comparative Example 1 | Abnormal |
| Comparative Example 2 | Abnormal |

Referring to Table 3, it can be seen that the examples, in which coating was performed along the inner lateral surface of the pouch housing part, exhibited abnormal in the evaluation of vibration performance and improved safety of the battery.

On the other hand, it can be seen that the comparative examples, in which coating was performed along the central surface of the housing portion or the peripheral portion of the pouch, exhibited abnormal in the evaluation of vibration performance, and there was a limitation in improving the safety of the battery.

Therefore, it was confirmed that even if the coating portion is formed on the pouch, it might affect the improvement of safety depending on the formation position of the coating part.

What is claimed is:

1. A lithium secondary battery comprising:
an electrode assembly; and
a pouch in which the electrode assembly is housed, wherein the pouch comprises:
a housing portion configured to house the electrode assembly;
a peripheral portion around the housing portion; and
a coating portion formed along an inner lateral surface of the housing portion and spaced apart from a side portion of the electrode assembly.

2. The lithium secondary battery according to claim 1, wherein the pouch comprises a terrace region defined by a separation space between the coating portion and the side portion of the electrode assembly.

3. The lithium secondary battery according to claim 2, wherein a ratio of an average width of the terrace region in a long-axis direction to a long-axis length of the housing portion is ⅕ to 1/50.

4. The lithium secondary battery according to claim 1, wherein a ratio of an average thickness of the coating portion to an average thickness of the pouch is 1/10 to 1/50.

5. The lithium secondary battery according to claim 1, wherein the housing portion further comprises a central surface facing the electrode assembly in a thickness direction thereof, and
the coating portion is formed on the inner lateral surface of the housing portion and is not formed on the central surface.

6. The lithium secondary battery according to claim 1, wherein the peripheral portion comprises a sealing surface, and the coating portion is not formed on the sealing surface.

7. The lithium secondary battery according to claim 6, wherein the housing portion comprises a first housing portion and a second housing portion which face each other, and the peripheral portion further comprises a folding surface which divides the first housing portion and the second housing portion.

8. The lithium secondary battery according to claim 7, wherein the coating portion is not formed on the folding surface.

9. The lithium secondary battery according to claim 1, wherein the pouch has a laminate structure comprising a sealant layer, a metal layer and a coating layer.

10. The lithium secondary battery according to claim 9, wherein the sealant layer includes a polyolefin resin, the metal layer includes aluminum, and the coating layer includes nylon.

11. The lithium secondary battery according to claim 10, wherein the coating portion has a greater tensile strength than a tensile strength of the sealant layer.
